(19) United States
(12) Patent Application Publication
(10) Pub. No.: US 2023/0078042 A1
(43) Pub. Date: Mar. 16, 2023

(54) SYSTEMS AND METHODS OF GROUPING MICROMOBILITY VEHICLES

(71) Applicant: Honda Motor Co., Ltd., Tokyo (JP)

(72) Inventor: Soroush Jalali, Ann Arbor, MI (US)

(21) Appl. No.: 17/476,978

(22) Filed: Sep. 16, 2021

(51) Int. Cl. G01C 21/34; G08G 1/16; G01C 21/28; B60Q 9/00

(52) U.S. Cl. CPC G01C 21/3438; G08G 1/161; G08G 1/166; G01C 21/28; B60Q 9/00

(57) ABSTRACT

A system for use in grouping micromobility vehicles. The system includes a communication device associated with each of a plurality of micromobility vehicles, the communication device configured to transmit location data associated with a respective micromobility vehicle. A server is communicatively coupled with each communication device. The server is configured to receive the location data from each communication device, wherein the location data includes at least one of a current location, a direction of travel, or a destination of the plurality of micromobility vehicles, determine a navigational route for each micromobility vehicle, wherein the navigational route is configured to group the plurality of micromobility vehicles en route to a respective destination of each micromobility vehicle, and transmit the navigational route to each communication device.

### BACKGROUND

The present disclosure relates generally to micro-mobility vehicles, such as electric scooters, and, more specifically, to systems and methods of grouping micromobility vehicles.

Micromobility vehicle usage, including the use of electric scooters, has surged in recent years. The expansion of micromobility vehicle availability has provided people with an alternative to traditional mobility solutions, such as public transportation or private motor vehicles, which may not always be viable from an efficiency, cost, and/or time perspective. However, several unique issues have surfaced as the number of scooters on roadways has increased. For example, infrastructure built for cars, cyclists, and pedestrians are not specifically designed to accommodate scooters. Thus, the scooters are being ridden on roads, bike lanes, and pedestrian sidewalks even though these paths were not originally designed to accommodate the scooters. In addition, scooters are less visible, are sometimes used by inexperienced riders, and are often faster than bikes making them vulnerable targets for fast moving cars when they are ridden on the road. On the other hand, the same factors may create hazardous situations for pedestrians when scooters are ridden on a sidewalk.

### BRIEF DESCRIPTION

In one aspect, a system for use in grouping micromobility vehicles is provided. The system includes a communication device associated with each of a plurality of micromobility vehicles, the communication device configured to transmit location data associated with a respective micromobility vehicle. A server is communicatively coupled with each communication device. The server is configured to receive the location data from each communication device, wherein the location data includes at least one of a current location, a direction of travel, or a destination of the plurality of micromobility vehicles, determine a navigational route for each micromobility vehicle, wherein the navigational route is configured to group the plurality of micromobility vehicles en route to a respective destination of each micromobility vehicle, and transmit the navigational route to each communication device.

In another aspect, a system for use in grouping micromobility vehicles is provided. The system includes a communication device associated with each of a plurality of micromobility vehicles, the communication device configured to transmit location data associated with a respective micromobility vehicle. A server is communicatively coupled with each communication device. The server is configured to receive a verification signal from each communication device, wherein the verification signal is associated with a request to link the plurality of micromobility vehicles as a group of micromobility vehicles, receive the location data from each communication device, wherein the location data includes at least one of a current location, a direction of travel, or a destination of the group of micromobility vehicles, determine a navigational route for the group of micromobility vehicles, wherein the navigational route is determined based on at least one roadway safety criterion that includes a roadway width, the presence of a designated micromobility lane, a posted speed limit, and current traffic conditions, and transmit the navigational route to at least one communication device in the group.

In yet another aspect, a method of grouping micromobility vehicles is provided. The method includes receiving, from a communication device associated with each of a plurality of micromobility vehicles, location data associated with a respective micromobility vehicle, wherein the location data includes at least one of a current location, a direction of travel, or a destination of the plurality of micromobility vehicles, determining a navigational route for each micromobility vehicle, wherein the navigational route is configured to group the plurality of micromobility vehicles en route to a respective destination of each micromobility vehicle, and transmitting the navigational route to each communication device.

### BRIEF DESCRIPTION OF THE DRAWINGS

FIG. 1 is a block diagram illustrating an example routing system for use in grouping micromobility vehicles.

FIG. 2 illustrates an example method of grouping micromobility vehicles that may be performed by the routing system shown in FIG. 1.

FIG. 3 illustrates another example method of grouping micromobility vehicles that may be performed by the routing system shown in FIG. 1.

FIG. 4 illustrates another example method of grouping micromobility vehicles that may be performed by the routing system shown in FIG. 1.

### DETAILED DESCRIPTION

The embodiments described herein relate generally to systems and methods of grouping micromobility vehicles for use in establishing micro-mobility vehicle safety. In the following examples, micromobility vehicle (e.g., scooter) users may provide their destination to a routing system, such as a central server, via their phone or a computing device included in their scooter. In one embodiment, the routing system is programmed with an algorithm that determines navigational routes for one or more disparate groups of scooters. The navigational routes enable groups or clusters of scooters to be created, such as en route to respective destinations or at a specified safe location or rendezvous point. Alternatively, scooter riders could team up and create a group at a common starting location, as is commonly the case with groups of families and friends. In either scenario, clustering multiple scooters together into groups increases the visibility of the riders to other occupants of a roadway, thus enhancing safety for the riders.

The scooter's location may be tracked to provide the rider with real-time updates of their destination, optimal route, and approximate arrival time. Scooter location data may also be provided to other users of the roadway. For example, in some embodiments, the algorithm generates a navigational route that directs the scooters to travel along a roadway used by motor vehicles. In such a case, the location data may be transmitted to vehicles approaching a group of scooters to alert the driver of the number, destination, and/or anticipated movements of the group. For example, an icon showing a group of scooters may be displayed on the navigational map of an approaching vehicle to provide advance notice to the driver. Once the group arrives or is close to arriving at the destination, the group may be instructed to leave the road and park in a safe area, and notified that their mission is complete.

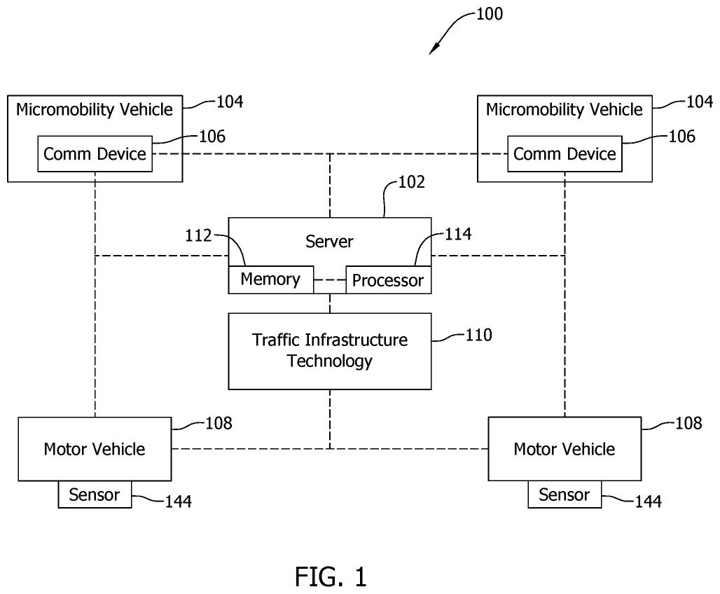

FIG. 1 is a block diagram illustrating an example routing system 100 for use in establishing micromobility vehicle safety. In the exemplary embodiment, routing system 100 includes a server 102 that is communicatively coupled with a plurality of micromobility vehicles 104. For example, a respective communication device 106 may be associated with each micromobility vehicle 104. Communication device 106 is any device capable of transmitting and receiving data, such as navigational data and location data, as will be described in more detail below. Communication device 106 may also be capable of displaying and/or providing navigational feedback to a rider thereof. In one example, communication device 106 is installed on a respective micromobility vehicle 104. Alternatively, communication device 106 is owned by the rider, such as a smart phone or other personal communication device, and may be temporarily linked with the respective micromobility vehicle 104, such as during a rental period. Accordingly, in some embodiments, a vehicle rider may interface with an application installed on communication device 106 to enable grouping and navigation for the rider, as will be described in more detail below.

Server 102 and/or micromobility vehicles 104 may also be communicatively coupled with one or more motor vehicles 108. In addition, traffic infrastructure technology 110, such as smart intersections and the like, may be installed on roadways traveled by micromobility vehicles 104 and motor vehicles 108. In one example, traffic infrastructure technology 110 includes any sensing and/or visual imaging device capable of monitoring the presence and/or movements of pedestrians and vehicles relative a respective position. Data collected by traffic infrastructure technology 110 may be transmitted to server 102 for further processing, as will be described in more detail below, or may be transmitted to nearby motor vehicles 108. In an alternative embodiment, traffic infrastructure technology 110 may also communicate directly with micromobility vehicles 104.

In the exemplary embodiment, server 102 includes a memory 112 and a processor 114, including hardware and software, coupled to memory 112 for executing programmed instructions. Processor 114 may include one or more processing units (e.g., in a multi-core configuration) and/or include a cryptographic accelerator (not shown). Server 102 is programmable to perform one or more operations described herein by programming memory 112 and/or processor 114. For example, processor 114 may be programmed by encoding an operation as executable instructions and providing the executable instructions in memory 112.

Processor 114 may include, but is not limited to, a general purpose central processing unit (CPU), a microcontroller, a microprocessor, a reduced instruction set computer (RISC) processor, an open media application platform (OMAP), an application specific integrated circuit (ASIC), a programmable logic circuit (PLC), and/or any other circuit or processor capable of executing the functions described herein. The methods described herein may be encoded as executable instructions embodied in a computer-readable medium including, without limitation, a storage device and/or a memory device. Such instructions, when executed by processor 114, cause processor 114 to perform at least a portion of the functions described herein. The above examples are for example purposes only, and thus are not intended to limit in any way the definition and/or meaning of the term processor.

Memory 112 is one or more devices that enable information such as executable instructions and/or other data to be stored and retrieved. Memory 140 may include one or more computer-readable media, such as, without limitation, dynamic random access memory (DRAM), synchronous dynamic random access memory (SDRAM), static random access memory (SRAM), a solid state disk, and/or a hard disk. Memory 112 may be configured to store, without limitation, executable instructions, operating systems, applications, resources, installation scripts and/or any other type of data suitable for use with the methods and systems described herein.

Instructions for operating systems and applications are located in a functional form on non-transitory memory 112 for execution by processor 114 to perform one or more of the processes described herein. These instructions in the different implementations may be embodied on different physical or tangible computer-readable media, such as memory 112 or another memory, such as a computer-readable media (not shown), which may include, without limitation, a flash drive and/or thumb drive. Further, instructions may be located in a functional form on non-transitory computer-readable media, which may include, without limitation, smart-media (SM) memory, compact flash (CF) memory, secure digital (SD) memory, memory stick (MS) memory, multimedia card (MMC) memory, embedded-multimedia card (e-MMC), and micro-drive memory. The computer-readable media may be selectively insertable and/or removable from server 102 to permit access and/or execution by processor 114. In an alternative implementation, the computer-readable media is not removable.

In operation, routing system 100 is operable to direct two or more micromobility vehicles 104 to form a group or cluster of vehicles to enhance the safety of the riders and of other occupants of roadways, walkways, and/or designated lanes in which micromobility vehicles 104 are capable of traveling. For example, the group of micromobility vehicles may be formed and then directed by routing system 100 to travel in a manner that enhances their visibility to other occupants of a roadway. Their visibility may be enhanced by directing the group to use the same navigational route to reach a destination while maintaining spacing between other riders that is less than a predefined distance. For example, location data for each micromobility vehicle 104 may be provided to server 102, and server 102 may transmit alerts to the communication device 106 of micromobility vehicles 104 that are spaced from other riders by greater than the predefined distance. In an alternative embodiment, such processing may be performed onboard the respective micromobility vehicle 104. Thus, the group has greater visibility to other roadway occupants than any individual rider alone.

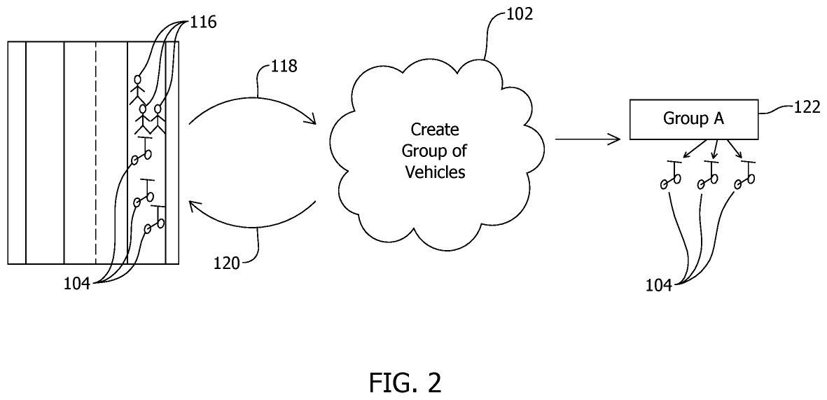

Referring to FIG. 2, routing system 100 may form a group of vehicles before riding has begun. For example, micromobility vehicles 104 available for use may be selected by one or more riders 116. In one embodiment, communication devices 106 associated with the selected micromobility vehicles 104 may transmit 118 a request to use micromobility vehicles 104 and to be linked for navigational purposes. Server 102 may then transmit 120 validation of the request to use the selected micromobility vehicles 104. The request for validation may be displayed on the associated communication device 106 (shown in FIG. 1) for selection by riders 116. Server 102 receives verification of the request, and links the group for a duration, such as until the group reaches its destination.

Each member and/or vehicle in the group may be assigned a unique identifier. The unique identifier may be generated by communication device 106 upon receiving user profile data from the rider, and/or by known hashing techniques (e.g., based on location, serial number of the communication device, and/or the current date and time). Creating the user profile enables trip history information to be provided to the individual rider and/or the current group in which the rider is associated. Thus, motor vehicles may be notified and provided with the ability to identify each micromobility user within the group, thereby verifying the correct users are within the group.

Once the group is formed, such as group A 122, routing system 100 may be used to navigate group A 122 to a desired destination. For example, server 102 may receive location data from group A 122, such as at least one of a current location, a direction of travel, or a desired destination of group A 122. Routing system 100 then determines a navigational route for group A 122 based on at least one roadway safety criterion. Example safety criteria includes, but is not limited to including, roadway width, the presence of a designated micromobility or bike lane, a posted speed limit of a roadway, and current traffic conditions. That is, paths having a greater width, a designated lane, a posted speed limit below a threshold, and/or light traffic may be rated higher on a safety scale. Thus, micromobility vehicle safety is established by generating navigational routes that are determined to include comparatively safer paths for micromobility vehicle travel.

Based on the above criteria, routing system 100 may determine that some paths or roadways have a consistently high safety rating. Accordingly, in some embodiments, routing system 100 may consistently generate navigational routes to include these paths. Thus, these paths may inherently be established as common micromobility vehicle routes, which may enhance safety by increasing the awareness of other roadway occupants to be on the lookout for micromobility vehicles that commonly share the roadway.

In some embodiments, the application interface on communication device 106 may be used to display a map showing the current location and/or different route options for the group of riders. The route options are routes that are generated by joining disparate groups of vehicles having different common routes and/or rendezvous points. A respective route option is selectable by the rider on the interface.

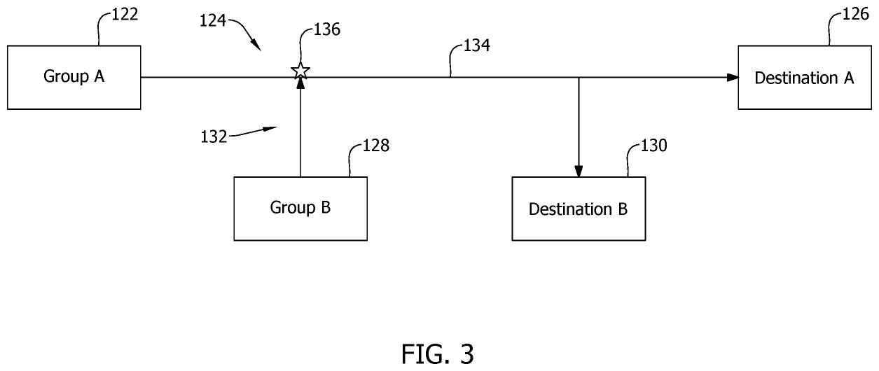

Referring to FIG. 3, a group of micromobility vehicles 104, such as group A 122, may be formed and directed to travel along route A 124 to its desired destination A 126. In some embodiments, one or more additional micromobility vehicles 104, such as those included in group B 128, may rendezvous with group A 122 to form a larger group en route to its own desired destination B 130. For example, the vehicles of group A 122 and group B 128 may originate from different starting locations, and route B 132 may be generated to include a common path 134 that is en route to the respective destination of each group, and that is shared with route A 124. For example, a rendezvous point 136 that is en route to the respective destinations may be determined and included in route A 124 and route B 132. Server 102 may also transmit instructions to each group to wait at rendezvous point 136 for the other group to form the larger group of vehicles. Thus, the larger group is more visible to other roadway occupants.

In the illustrated embodiment, route B 132 is not a direct route to destination B 130. While traveling along route B 132 may increase the travel time of group B 128 to its destination, route B 132 is generated to enhance the safety of both group A 122 and of group B 128. The enhanced safety is provided as a result of the larger grouping of micromobility vehicles and/or if common path 134 has a higher safety rating than the direct route to destination B 130.

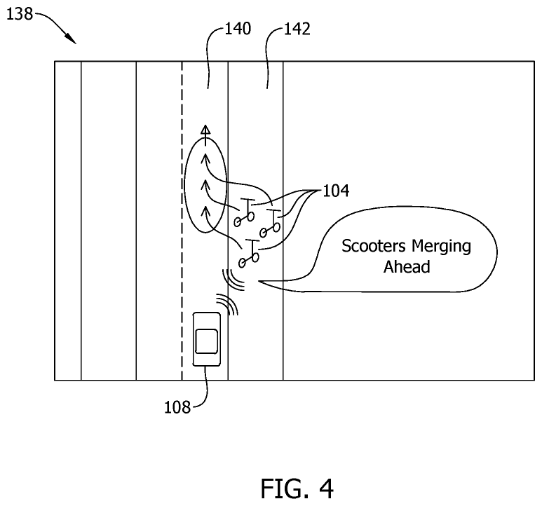

Referring to FIG. 4, the planned route 138 includes a roadway 140 typically used by motor vehicles 108, and a pedestrian walkway 142. In the example embodiment, routing system 100 may direct micromobility vehicles 104 to use roadway 140 or walkway 142, and/or to switch therebetween, based on the current safety level of roadway 140 while en route to the destination. In some instances, micromobility vehicles 104 may be directed to merge onto roadway 140 from walkway 142 at predetermined locations along planned route 138. Thus, the merging of vehicles onto roadway 140 is predetermined, and advance notice of any expected variations in the trajectory of micromobility vehicles 104 may be provided to approaching motor vehicles 108 via server 102, or via direct vehicle-to-vehicle communication. Advance notice that motor vehicle 108 is approaching a group of micromobility vehicles 104 may also be provided to motor vehicle via traffic infrastructure technology 110 (shown in FIG. 1), as described above.

Such advance notice may be displayed on the dashboard or interior display of motor vehicle 108. Motor vehicle 108 may also be alerted to the number and destination of the group that would be sharing the road with them either via a voice assist or with a visual or haptic cue. Alternatively, the navigational map of the vehicle could be updated to show a group of scooters using the main road to increase visibility of the scooters for all drivers.

Referring to FIGS. 1 and 4, motor vehicles 108 have at least one sensor 144, such as LIDAR, RADAR, a camera, and the like. Sensor 144 monitors the proximity of its associated motor vehicle 108 to objects around it, such as micromobility vehicles 104 on a shared roadway. Sensor data obtained by sensor 144 may be transmitted to other motor vehicles 108 in close proximity to the group. The sensor data may also be used to verify the number of micromobility vehicles 104 in the upcoming group. If the number of vehicles in the group cannot be verified, the group may be notified that they are either missing a member or an additional unauthorized member is following them on the road.

Additionally, the system onboard the vehicle(s) can monitor and help ensure the group's safety on the road by communicating and alerting the group if a member is off-course/route and/or whether there are any potential hazards or traffic concerns in the future that could endanger them and their mission. If a potential hazard is predicted or detected, alert may be sent to other motor vehicles, traffic lights, and other road users. In the event of an accident, an emergency call could be initiated automatically and the location of the accident sent to the proper authorities.

The embodiments described herein relate to establishing micromobility vehicle safety. The routing system is programmed with an algorithm that determines navigational routes for one or more disparate groups of scooters. The navigational routes enable groups or clusters of scooters to be created, such as en route to respective destinations or at a specified safe location or rendezvous point. Alternatively, scooter riders could team up and create a group at a common starting location, as is commonly the case with groups of families and friends. In either scenario, clustering multiple scooters together into groups increases the visibility of the riders to other occupants of a roadway, thus enhancing safety for the riders. Advanced sensing and communication technology is also used herein to enhance rider safety.

Exemplary embodiments of a routing system for use in establishing micro-mobility vehicle safety are described above in detail. Although the system is described and illustrated in association with electric scooters, the invention is also intended for use with other mobility solutions as well. Moreover, it should also be noted that the components of the invention are not limited to the specific embodiments described herein, but rather, aspects of each component may be utilized independently and separately from other components and methods described herein.

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for use in grouping micromobility vehicles, the system comprising:
a communication device associated with each of a plurality of micromobility vehicles, the communication device configured to transmit location data associated with a respective micromobility vehicle; and
a server communicatively coupled with each communication device, the server configured to:
receive the location data from each communication device, wherein the location data includes at least one of a current location, a direction of travel, or a destination of the plurality of micromobility vehicles;
determine a navigational route for each micromobility vehicle, wherein the navigational route is configured to group the plurality of micromobility vehicles en route to a respective destination of each micromobility vehicle; and
transmit the navigational route to each communication device.

2. The system in accordance with claim 1, wherein the server is further configured to determine the navigational route for the plurality of micromobility vehicles that originate from different starting locations.

3. The system in accordance with claim 1, wherein the server is further configured to:
determine a common path that is en route to the respective destination of each micromobility vehicle; and
generate the navigational route to include the common path.

4. The system in accordance with claim 1, wherein the server is further configured to determine the navigational route based on at least one roadway safety criterion that includes a roadway width, the presence of a designated micromobility lane, a posted speed limit, and current traffic conditions.

5. The system in accordance with claim 1, wherein the server is further configured to:
determine a rendezvous point that is en route to the respective destination of each micromobility vehicle; and
generate the navigational route to include the rendezvous point and instructions to wait at the rendezvous point for at least one other micromobility vehicle.

6. The system in accordance with claim 1, wherein the server is further configured to:
monitor the current location of the plurality of micromobility vehicles; and
transmit the location data to a motor vehicle approaching the plurality of micromobility vehicles.

7. The system in accordance with claim 1, wherein the server is further configured to:
receive, from traffic infrastructure technology, location data associated with the plurality of micromobility vehicles; and
transmit the location data to a motor vehicle approaching the plurality of micromobility vehicles.

8. The system in accordance with claim 1, wherein the server is further configured to:
receive sensor data from a motor vehicle in visual sensing proximity to the plurality of micromobility vehicles; and
transmit, using vehicle-to-vehicle communication, the sensor data to at least one other motor vehicle.

9. A system for use in grouping micromobility vehicles, the system comprising:
a communication device associated with each of a plurality of micromobility vehicles, the communication device configured to transmit location data associated with a respective micromobility vehicle; and
a server communicatively coupled with each communication device, the server configured to:
receive a verification signal from each communication device, wherein the verification signal is associated with a request to link the plurality of micromobility vehicles as a group of micromobility vehicles;
receive the location data from each communication device, wherein the location data includes at least one of a current location, a direction of travel, or a destination of the group of micromobility vehicles;
determine a navigational route for the group of micromobility vehicles, wherein the navigational route is determined based on at least one roadway safety criterion that includes a roadway width, the presence of a designated micromobility lane, a posted speed limit, and current traffic conditions; and
transmit the navigational route to at least one communication device in the group.

10. The system in accordance with claim 9, wherein, based on the location data, the server is further configured to transmit an alert to at least one of the plurality of micromobility vehicles to maintain spacing between the plurality of micromobility vehicles that is less than a predefined distance.

11. The system in accordance with claim 9, wherein the server is further configured to:
monitor the current location of the group of micromobility vehicles; and
transmit the location data to a motor vehicle approaching the group of micromobility vehicles.

12. The system in accordance with claim 9, wherein the server is further configured to:
receive, from traffic infrastructure technology, location data associated with the group of micromobility vehicles; and
transmit the location data to a motor vehicle approaching the group of micromobility vehicles.

13. The system in accordance with claim 9, wherein the server is further configured to:
receive sensor data from a motor vehicle in visual sensing proximity to the group of micromobility vehicles; and
transmit, using vehicle-to-vehicle communication, the sensor data to at least one other motor vehicle.

14. A method of grouping micromobility vehicles, the method comprising:
receiving, from a communication device associated with each of a plurality of micromobility vehicles, location data associated with a respective micromobility vehicle, wherein the location data includes at least one of a current location, a direction of travel, or a destination of the plurality of micromobility vehicles;
determining a navigational route for each micromobility vehicle, wherein the navigational route is configured to group the plurality of micromobility vehicles en route to a respective destination of each micromobility vehicle; and
transmitting the navigational route to each communication device.

15. The method in accordance with claim 14 further comprising determining the navigational route for the plurality of micromobility vehicles that originate from different starting locations.

16. The method in accordance with claim 14 further comprising:
determining a common path that is en route to the respective destination of each micromobility vehicle; and
generating the navigational route to include the common path.

17. The method in accordance with claim 14 further comprising determining the navigational route based on at least one roadway safety criterion that includes a roadway width, the presence of a designated micromobility lane, a posted speed limit, and current traffic conditions.

18. The method in accordance with claim 14 further comprising:
monitoring the current location of the plurality of micromobility vehicles; and
transmitting the location data to a motor vehicle approaching the plurality of micromobility vehicles.

19. The method in accordance with claim 14 further comprising:
receiving, from traffic infrastructure technology, location data associated with the plurality of micromobility vehicles; and
transmitting the location data to a motor vehicle approaching the plurality of micromobility vehicles.

20. The method in accordance with claim 14 further comprising:
receiving sensor data from a motor vehicle in visual sensing proximity to the plurality of micromobility vehicles; and
transmitting, using vehicle-to-vehicle communication, the sensor data to at least one other motor vehicle.
